(19) United States
(12) Patent Application Publication
(10) Pub. No.: US 2010/0264627 A1
(43) Pub. Date: Oct. 21, 2010

(54) Receptacle for an Adapter Having a Trailer Ball

(75) Inventor: Jens Mueller, Backnang (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/669,782

(22) PCT Filed: Jun. 27, 2008
(86) PCT No.: PCT/EP2008/005257

§ 371 Date: Jun. 16, 2010

(30) Foreign Application Priority Data
Jul. 19, 2007 (DE) 10 2007 033 537.9

(51) Int. Cl. B60D 1/00

(52) U.S. Cl. 280/515

(57) ABSTRACT

A receptacle device that is attachable to a motor vehicle includes a receiving tube into which an insertion tube of an adapter having a trailer ball can be inserted. The insertion tube is held in the receptacle tube with the help of a splint. In order to eliminate play between the insertion tube and the splint, the insertion tube is pressed against the splint by a pressure piece. A first segment of the pressure piece fits the inner diameter of the receiving tube, so that the pressure piece can be held by said receiving tube, while a second segment engages precisely in the insertion tube in order to be held thereby.

This application is a national stage of PCT International Application No. PCT/EP2008/005257, filed Jun. 27, 2008, which claims priority under 35 U.S.C. §119 to German Patent Application No. 10 2007 033 537.9, filed Jul. 19, 2007, the entire disclosure of which is herein expressly incorporated by reference.

### BACKGROUND AND SUMMARY OF THE INVENTION

The present invention relates to a receptacle device for an adapter having a trailer ball, which is mounted to a motor vehicle. Such devices, which are commonly used, especially in North America, have a receiving tube, into which an insertion tube of the adapter can be inserted. A splint is also part of the receptacle device, which splint can be pushed through the receiving tube and through the insertion tube (which fits when inserted), to hold the insertion tube in the receiving tube.

A certain amount of play is permitted by the splint, which means that the insertion tube can move slightly in the receiving tube. Such play can be very annoying, especially if a trailer is coupled to the trailer ball.

One object of the invention, therefore, is to provide a rigid hold of the insertion tube in the receiving tube.

This and other objects and advantages are achieved by the receptacle device according to the invention, which includes an arrangement for pressing the insertion tube against the splint, so that, if the insertion tube is pressed against the splint, the play is minimized. As a result, an insertion tube no longer moves relative to the splint, and a secure hold of the insertion tube in the receiving tube is achieved.

Preferably, a force is exerted on the insertion tube from the interior, by a pressure piece that engages the receiving tube. Such a pressure piece can comprise a first segment, which holds it at the receiving tube, and a second segment, which engages the insertion tube, to be held against it. If the pressure piece can be held at both tubes (the receiving tube and the insertion tube), a secure hold of the pressure piece and an optimum force distribution and force exertion are ensured at the same time.

Large forces can best be applied with the help of a lever, which brings pressure piece from a resting position into an engagement position and back. As the insertion tubes can have different lengths, means are also provided for adapting the engagement depth of the pressure piece in the receiving tube to varying lengths of the insertion tube.

The invention also provides a motor vehicle with a receptacle device of the type according to the invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a partial cross section view, which shows a receptacle device according to the invention with an adapter inserted therein, before bracing; and

FIG. 2 is a partial cross sectional view, which shows the receptacle device of FIG. 1 after bracing.

### DETAILED DESCRIPTION OF THE DRAWINGS

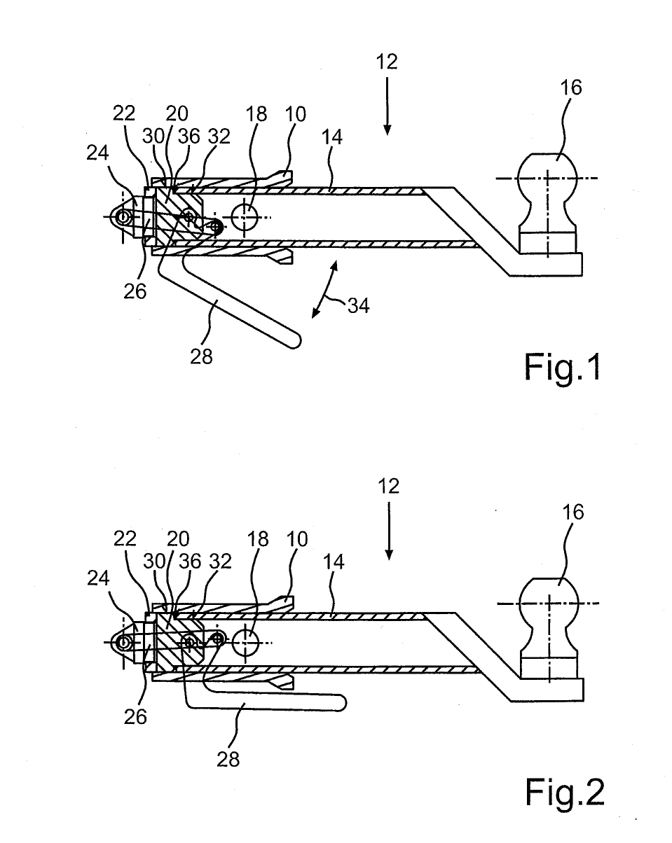

Referring to FIG. 1, an adapter 12 can be inserted into a receiving tube 10. In particular, an insertion tube 14 of the adapter, to which is added a coupling piece with a trailer ball 16 at the outside of the receiving tube 10, is held in the receiving tube 10 with the help of a splint (not shown). The latter is guided through openings 18, which are provided in the receiving tube 10 and in the insertion tube 14, and must be aligned to enable the insertion of the splint. In any case, a small amount of play remains, so that the insertion tube 14 and thus the entire adapter 12 can move easily relative to the receiving tube 10.

Such movement is suppressed by pressure piece 20, which engages the receiving tube 10 from its inner side. The pressure piece is arranged at a ring 22 which has an internal thread, and into which can be screwed a lever extension 24 having an external thread with a variable depth. The lever extension is connected to an end of a fork of an L-shaped lever 28 by means of a lever rod 26, which can be moved relative thereto. The other end of the fork is pivoted to the pressure piece 20. The pressure piece 20 has a first segment 30 with an outer diameter that fits precisely in the receiving tube 10, and a second segment 32 with an outer diameter that fits precisely in the insertion tube 14.

In the position shown in FIG. 1, the pressure piece 20 does not exert a force on the insertion tube. If the lever 28 is now pivoted into the position shown in FIG. 2 corresponding to the arrow 34, a shoulder 36 of the pressure piece 20 comes into abutment with the insertion tube 14 and exerts a pressure thereon. The insertion tube 14 is pushed to the outside, but is however prevented from further movement by the splint guided in the openings 18. As a result, the insertion tube 14 is pressed rigidly against the splint, and is held thereby in the receiving tube 10. As the length of the insertion tube 14 can vary from one insertion tube to the next, the pressure piece 20 has to obtain the appropriate engagement depth in the engagement position according to FIG. 2. For this purpose, the ring 22 is screwed sufficiently far, but not too far, onto the external thread of the lever extension 24.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-6. (canceled)

7. A receptacle device which can be attached to a motor vehicle for receiving an insertion tube of an adapter having a trailer ball, said receptacle device comprising:
a receiving tube that is configured to accommodate insertion of said insertion tube;
a splint for holding the insertion tube in the receiving tube, which splint can be pushed through openings in the receiving tube and in an insertion tube, which is inserted therein; and
means for pressing the insertion tube against the splint.

8. The receptacle device according to claim 7, wherein said means for pressing comprises a pressure piece that engages the receiving tube.

9. The receptacle device according to claim 8, wherein the pressure piece comprises:
a first segment, which holds the pressure piece at the receiving tube; and
a second segment, with which the pressure piece engages the insertion tube, so as to be held thereby.

10. The receptacle device according to claim 8, wherein the pressure piece is movable from a resting position into an engagement position, and back by means of a lever.

11. The receptacle device according to Clam 8, further comprising means for adapting an engagement depth of the pressure piece in the receiving tube to varying lengths of the insertion tube.

12. A motor vehicle having a receptacle device according to claim 7.
